(19) United States
(12) Patent Application Publication
(10) Pub. No.: US 2018/0365396 A1
(43) Pub. Date: Dec. 20, 2018

(54) COPYRIGHT VERIFICATION SYSTEM

(71) Applicant: Joel Rucker, Raleigh, NC (US)

(72) Inventor: Joel Rucker, Raleigh, NC (US)

(21) Appl. No.: 15/624,028

(22) Filed: Jun. 15, 2017

(51) Int. Cl. G06F 21/10; G06F 21/62; H04L 9/32; G06F 21/60

(52) U.S. Cl. CPC G06F 21/105; G06F 21/6218; H04L 9/3247; G06F 2221/0775; G06F 21/602; G06Q 2220/16; H04L 9/3236

(57) ABSTRACT

The present invention discloses a verifiable lockbox registry for copyrightable work which insures verifiable and non-tamper date of creation for a work.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system for verifying the author of a copyrightable work. In particular, it relates to verified lockbox registry system for easily proving the authorship of a new copyrightable work.

### Description of Related Art

The creation of literary works such as books, movies, music, and the like are all protectable under copyright law. Initially, after creation, it can be difficult to prove who and when such works were created and it's possible for someone to steal from another if there is not sufficient way to prove who created a work and when. In the past, ownership proof has had a huge cost associated with it which, in some cases, is impossible to verify before filing for official US copyright protection.

Several methods of verifying copyrightable material are available but all suffer from difficulty in use and difficulty creating a way to keep such information from being tampered with or stolen, despite use of current systems. Accordingly, there is a need for a better system of protecting and determining the owner of copyrightable material.

### BRIEF SUMMARY OF THE INVENTION

The present invention relates to an online user uploading digital copyrightable material in a manner to verify originality (i.e. creator of the work), date, and who deposited the work. It creates virtual lockbox which insures chain of custody of the information for use at a later date. The system securely distributes the uploaded contents to one or more independent repositories to eliminate a single point of failure to support transaction integrity and provide assurances of protection from fraud.

Accordingly, in one embodiment, there is a system for copyright verification of a copyrightable work in digital form by a user comprising:
a) an online server for receiving the deposit of a copyrightable work having metadata associated therewith wherein the server can create a time and deposit record upon receipt of the copyrightable work;
b) a system associated with the server for creating a password associated with the deposited copyrightable work;
c) a system associated with the server that creates a digital encrypted file of the deposited copyrightable work;
d) a system associated with the server that publishes the deposited copyrightable work;
e) a system associated with the server that sends a copy of the deposited copyrightable work to one or more independent third party digital storage sites; and
f) a system for validating a verification withdrawal request.

In another embodiment, there is a method for creating verification of a copyrightable work in digital form by a user comprising:
a) uploading the digital copy of the copyrightable work to an online server wherein metadata is associated with the copyrightable work;
b) creating a password for the copyrightable work deposit and a time and deposit record;
c) creating an encrypted file of the copyrightable work;
d) publishing a copy of the copyrightable work;
e) sending a copy of the deposited copyrightable work to one or more independent third party digital storage sites; and
f) validate any requests for verification of the deposit.

### BRIEF DESCRIPTION OF THE DRAWINGS

FIG. 1 is a diagram of the present invention.

FIG. 2 is a flow chart of the method of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “Internet” refers to its normal usage to be the system, including the World Wide Web, by which content providers, such as text messaging providers, can supply web content, such as from a server, to be displayed or published on Internet connected client (or reader) computers operable to access and display the content via a web browser. Therefore, computers, networks, internet connections, operating systems, programs, data structures, processing units, system memory components, system busses, wireless connections, cookies, and other computing hardware and software, as known in the art, for Internet communication can be utilized in the present invention. Thus, without being bound by theory, or limited by lack of precise jargon, the description of the invention below is intended to be understood as being operable in the context of known means for operating websites, payment systems, computers, servers, and user-generated content, all as currently used for Internet activity, but lacking in the inventive features of the present invention.

As used herein the term “server” refers to a computing device communicatively coupled to a network, i.e. online, or connected to the Internet that manages network resources provided by the present invention with a user. A server may refer to a discrete computing device or may refer to an application that is managing resources, rather than the entire computing device. An edge proxy server may be a proxy server which is designed to run at the edge of the network, e.g. separating a local network from the Internet. The server will have storage associated therewith for filing one or more copies of the work that is controlled by the server and not a third party.

As used herein the term “user” refers to a computer user (smart phone, tablet, desktop, or the like) that has multiple programs or apps (application programs), each of which has their own text messaging system. For example, a user might be someone with both Facebook and LinkedIn on their phone needing to open two programs to view all their text messaging.

As used herein the term “copyrightable work” refers to any work which can be the subject of a US or other countries copyright laws. Included, but not limited to, are musical works, literary works, such as books and videos, and the like. The work will have metadata associated with it which can already be associated with the work or can be created on the server.

As used herein the term “verification” refers to the ability for the system of the present invention to create a chain of custody proof of when a copyrightable work was deposited, and by whom, to aid in the proof of when and who created a particular copyrightable work.

As used herein the term “metadata” refers to information on a document's properties. Metadata is usually composed of two parts—a definition part and a content part. The definition part of a property defines generally the type of property, client, project, customer, creator, date, etc. The definition part of a property may additionally comprise data type (such as text, number, date, time, Boolean, choose from list single-select, choose from list multi-select), sorting order, validation rules, automatic value calculation rules, access control information, and other information that the system may need in association with the use of the property in question. The content part of a property, on the other hand, specifies the value of the metadata, i.e. which client, which project, which customer, which creator, which date. For further example, specified values for a creator of the file or a creation date represent content of the metadata. In addition, a project which the document belongs to; a client who owns the document; a type of the document (letter, assignment, publication, order etc.); name of the document are examples of the content of metadata. Despite the plural form of metadata, in this disclosure, the term metadata may also refer to a singular form. Therefore, an object being defined by “metadata” may in practice be defined by one or more pieces (i.e. property or properties) of metadata. In the present disclosure, term “properties” is used as a synonym for metadata, wherein “a property” is a piece of a metadata. Further, the term “property definition” refers to the definition part of a property and the term “property value” refers to the content part of a property. The term “property” may refer to either the definition part or the content part, or both.

As used herein the term “time and deposit” refers to the server providing the user a receipt that indicates at the very least the time and date and deposit record to show when the user has completed the work and deposited it.

As used herein the term “password” refers to a sequence of characters in a defined format that is desirably kept secret and used for controlling access to data.

As used herein the term “encrypted file” refers to a file for securing digital images from tampering to the extent that such digital images are deemed as legally admissible evidence.

As used herein the term “published” refers to placing the digital work in the public domain so that the general public has access to it from the moment of publication. For example, publishing the digital work to a web site, journal, or any other public means for publication that the general public can see.

As used herein the term “independent 3^{rd} party digital storage site” refers to a place to store the digital work that is not controlled or run by the server operator in such a manner that once transferred, they exercise independent control over the work. Thus, once transferred, if the server operator changes the work, the original version remains with the independent third party.

As used herein the term “verification” refers to the process of showing authentication of the work to the user or independent inquirers, courts, or the like.

### DRAWINGS

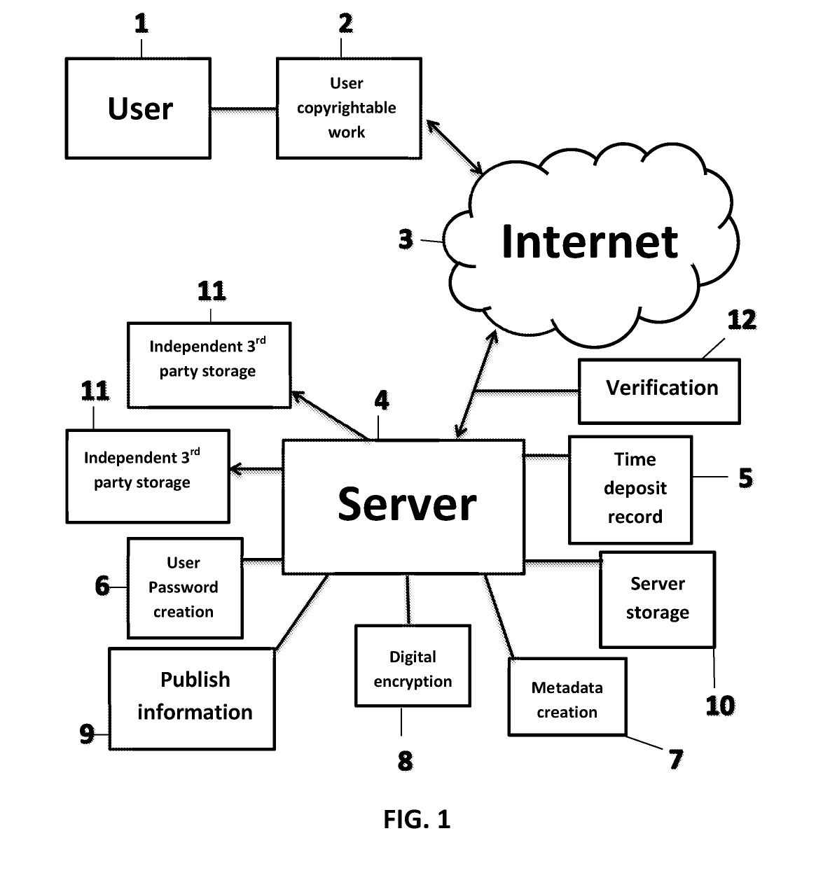

Now referring to the drawings, FIG. 1 is a diagram of the system of the present invention. In this view, user 1 has copyrightable work (CW) 2 which is deposited on server 4 through the Internet 3. The server 4 produces a time deposit record 5 and a password 6 for the user to use the server information. In this view, the server adds metadata 7. The server digitally encrypts 8 the CW, though in other embodiments, the user or other person could add this information. The server then publishes the information 9 and places at least one copy on its own server 10 and at least one copy to an independent third party storage site 11. In the event the work then needs to be verified 12, the server provides the necessary info to the user, other individual, or court etc. to help in the verification of the work, its date of deposit, and the user depositing it.

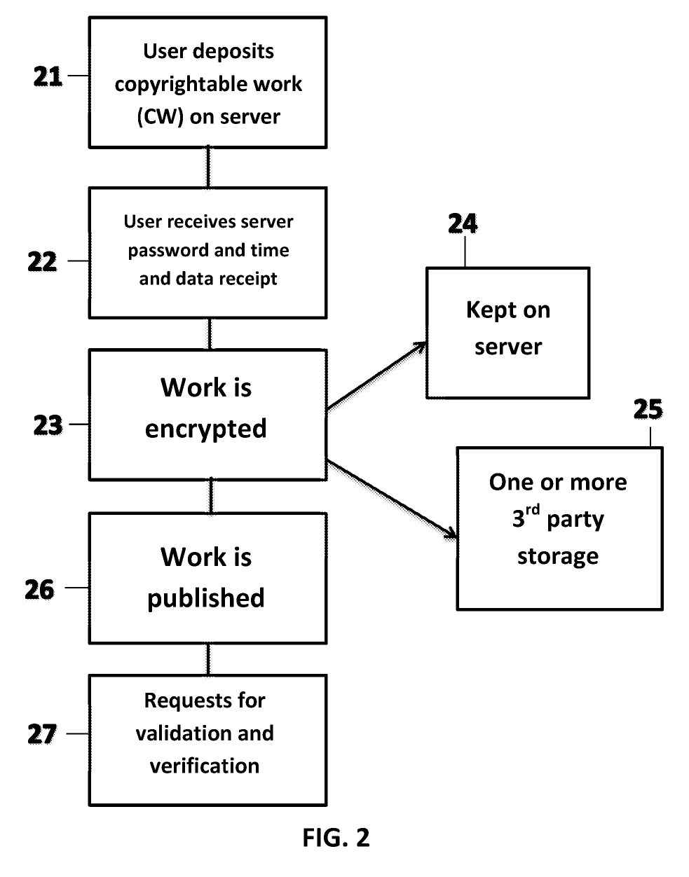

FIG. 2 is a flow chart of the method of the present invention. The user takes a digital copy of their CW and deposits it on the server 21. The user receives a password associated with the account (not an encryption password) and a time and date receipt from the server 22. The work is encrypted 23 and then a copy placed on the server 24 and one or more independent 3^{rd} party storage sites 25. The CW is then published 26 ensuring independence and a virtual lockbox of the information. If needed, requests for validation and verification 27 are then handled by the server.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for copyright verification of a copyrightable work in digital form by a user comprising:
a) an online server for receiving the deposit of a copyrightable work having metadata associated therewith wherein the server can create a time and deposit record upon receipt of the copyrightable work;
b) a system associated with the server for creating a password associated with the deposited copyrightable work;
c) a system associated with the server that creates a digital encrypted file of the deposited copyrightable work;
d) a system associated with the server that publishes the deposited copyrightable work;
e) a system associated with the server that sends a copy of the deposited copyrightable work to one or more independent third party digital storage sites; and
f) a system for validating a verification withdrawal request.

2. A method for creating verification of a copyrightable work in digital form by a user comprising:
a) uploading the digital copy of the copyrightable work to an online server wherein metadata is associated with the copyrightable work;
b) creating a password for the copyrightable work deposit and a time and deposit record;
c) creating an encrypted file of the copyrightable work;
d) publishing a copy of the copyrightable work;
e) sending a copy of the deposited copyrightable work to one or more independent third party digital storage sites; and
f) validate any requests for verification of the deposit.
